(19) United States
(12) Patent Application Publication
(10) Pub. No.: US 2003/0233191 A1
(43) Pub. Date: Dec. 18, 2003

(54) System and method for designating point and area in map

(76) Inventor: Katsuharu Hosoe, Okazaki-city (JP)

Correspondence Address: NIXON & VANDERHYE, PC, 1100 N GLEBE ROAD, 8TH FLOOR, ARLINGTON, VA, 22201-4714, US

(21) Appl. No.: 10/456,481

(22) Filed: Jun. 9, 2003

(30) Foreign Application Priority Data
Jun. 12, 2002 (JP) 2002-171596

(51) Int. Cl. G01C 21/32

(52) U.S. Cl. 701/208; 340/995.14

(57) ABSTRACT

A map is divided into sections of a square of 900″×900″, each of which is further divided into blocks of a square of 30″×30″, each of which is further divided into units of a square of 1″×1″, so that a region on the map can be hierarchically designated. Each section is defined with section codes of three digits; each block is defined with block codes of three digits in accordance with the relative positional relation in the section; and each unit is defined with unit codes of three digits in accordance with the relative positional relation in the block, so that each unit can be completely differentiated with nine digits composed of those three kinds of codes. Furthermore, an area code is added to those three codes to constitute an intrinsic code, so that an area including the certain unit is also designated.

### CROSS REFERENCE TO RELATED APPLICATIONS

This application is based on and incorporates herein by reference Japanese Patent Application No.2002-171596 filed on Jun. 12, 2002.

### FIELD OF THE INVENTION

The present invention relates to a system and method for designating, in a map, a point and an area that includes the point as a basis. A system and method for displaying the map and a system for guiding a traveling route shown in the map are also related to.

### BACKGROUND OF THE INVENTION

Latitude and longitude of a point is typically inputted to designate the point in an electronic map displayed in a device such as a car navigation system, a personal computer, or the like.

However, the method of designating the point in the map with the latitude and longitude involves input of the two unknown parameters of the latitude and longitude and complicated inputting operations. Because of using the two unknown parameters, moreover, the designation of a position is incorrect if the inputting order is wrong. Thus, this method is disadvantageous in that it has poor operability.

It is, therefore, proposed in U.S. Pat. Nos. 6,006,160 and 6,122,594 to make it possible to designate a point simply using an intrinsic code of one parameter. Here, to designate a point, a mesh having unit measures arranged latitudinally and longitudinally is defined to cover a target map. Since each of the unit measures has the intrinsic code of one parameter, a predetermined point can be designated without the two parameters of the latitude and longitude.

However, since the above intrinsic code only designates a certain point that is a two-dimensional geographical point, an area that includes the certain point is not designated with this intrinsic code alone.

### SUMMARY OF THE INVENTION

It is an object of the present invention to provide a system and method of designating a point and area in a map with an intrinsic code, a system and method of displaying a map along with designating an area, and a route guiding system utilizing the designated area.

To achieve the above object, an area that includes a point as a basis is designated in a map by the following. A point-designating code that corresponds to one of regions into which the map divided according to a coordinate system is assigned to the point. An area-designating code is assigned to the area. An intrinsic code is defined by combining the point-designating code with the area-designating code. The point is designated in the map by the point-designating code within the intrinsic code, and the area is designated in the map by the area-designating code within the intrinsic code. This structure enables an area that includes a point as a basis to be designated in a map with an intrinsic code in addition to the point.

Furthermore, a map including the designated area is displayed on a display after reading the map including the designated area from a map database. Furthermore, route guiding is executed according to a route that is set to reach a target and bypass the designated area.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing structure of a car navigation according to an embodiment of the present invention;

FIG. 2 is a schematic diagram showing hierarchical structure of a map according to the embodiment;

FIG. 3 is a diagram showing a table of section codes;

FIG. 4 is a diagram showing a table of block codes;

FIG. 5 is a diagram showing a table of unit codes;

FIG. 6 is a diagram showing structure of an intrinsic code;

FIG. 7 is a flow diagram explaining a first part of procedure of optimum route guiding by a controller;

FIG. 8 is a flow diagram explaining a second part of procedure of optimum route guiding by the controller;

FIG. 9 is a schematic diagram showing a display image by the optimum route guiding; and

FIG. 10 is a schematic diagram showing a display image by the optimum route guiding.

### DETAILED DESCRIPTION OF THE PREFERRED EMBODIMENTS

(First embodiment)

A car navigation system mounted on a vehicle will be explained below as an embodiment of the present invention.

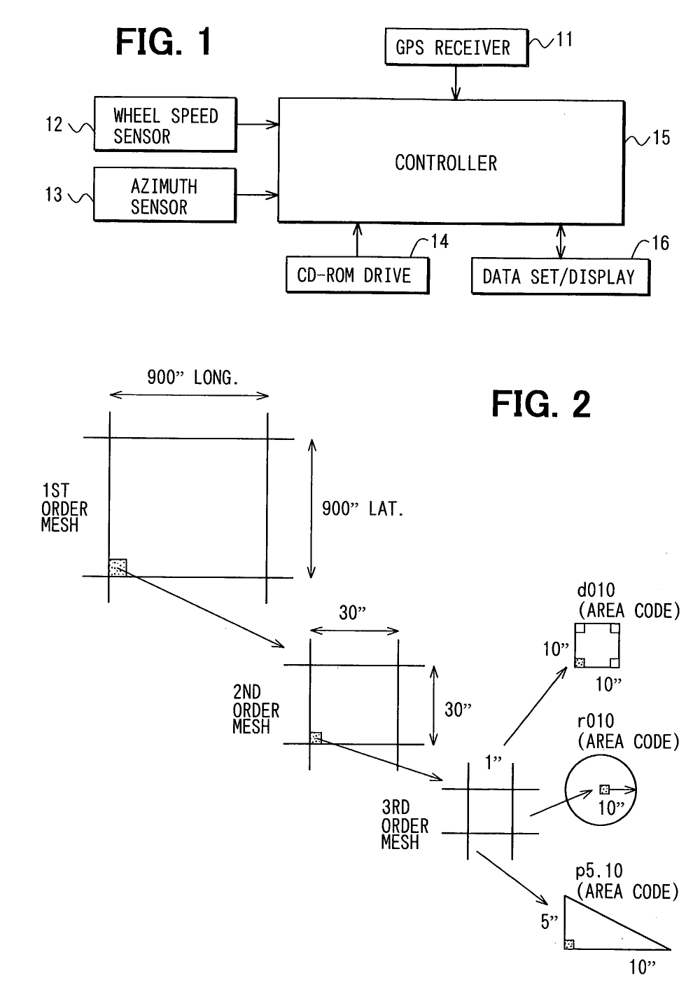

With a car navigation system, as shown in FIG. 1, there are connected: a GPS receiver 11 for receiving signals from GPS satellites; a wheel speed sensor 12; an azimuth sensor 13 composed of a yaw rate sensor or a geomagnetic sensor; a CD-ROM drive unit 14 for driving a CD-ROM stored with a map database; a controller 15, and a data set/display unit 16.

Here, this data set/display unit 16 is equipped with a screen for displaying a map, a speaker for announcing by voices, and a control panel for inputting various commands, numerical values, and so on.

The map database stored in the CD-ROM includes not only data for designating a point to be described later, but also data of road networks. The data of road networks are used for obtaining an optimum route from a departure point to a destination by combining nodes connecting links indicating roads.

The controller 15 is constructed of a computer, as equipped with a CPU, a ROM, a RAM, a hard disk, a modem, and so on. The CPU executes processing for calculating a current position of the vehicle on the basis of the received radio waves of the GPS receiver 11, and detection signals from the wheel speed sensor 12 and azimuth sensor 13. The CPU also executes processing for designating an area on the basis of an inputted code to be described later.

The CPU furthermore executes processing for setting an optimum route from a departure point to a destination on the basis of area information and road network data, processing which will be described later. The Dijkstra method is an instance of approaches for setting the optimum route. The CPU then executes processing for displaying the current position and optimum route set above, on a map displayed in the data set/display unit 16.

The CD-ROM is stored with the database of a map of an entire region, e.g., the entire country of Japan, which is expressed according to the latitude-longitude coordinates. Moreover, the aforementioned map database is so constructed that the entire map can be designated at the unit of a primary mesh composed of measures of latitude (lat.)×longitude (long.)=900 seconds×900 seconds (=900″×900″). This data base is also so constructed that the region in each measure of the primary mesh can be further designated at the unit of a secondary mesh composed of latitude×longitude of 30″×30″, and is further so constructed the region in each measure of the secondary mesh can be further designated at the unit of a ternary mesh composed of latitude×longitude=1″×1″. This relation is schematically illustrated to have hierarchical structure, as shown in FIG. 2.

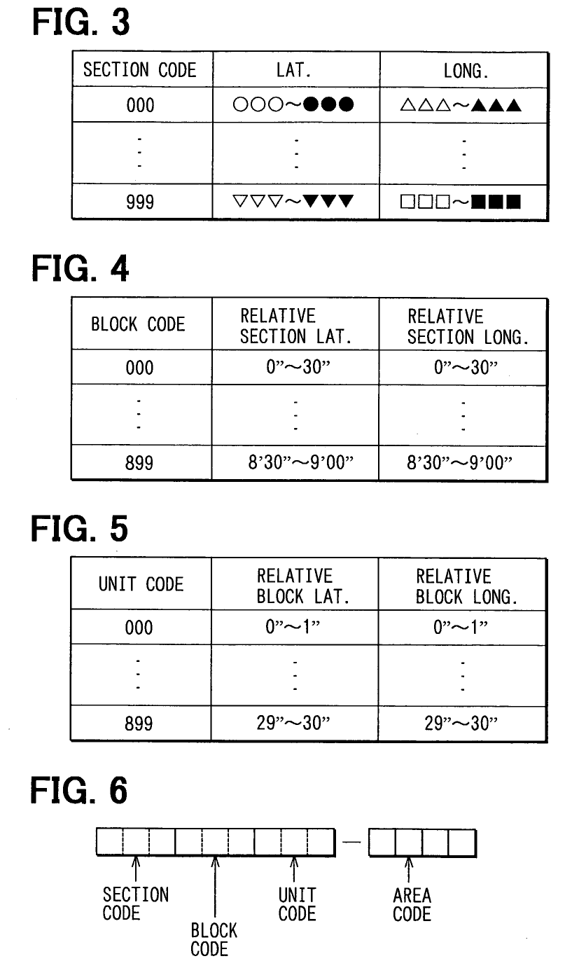

The hard disk of the controller 15 is stored in a tabulated form with code numbers for designating the measures of the primary mesh, as enumerated in a table of FIG. 3. The primary mesh is composed of 1,000 measures at most, the code numbers of which are represented by three-digit numbers from “000” to “999,” corresponding one-to-one to the individual measures of the primary mesh. In the following discussion, these three-digit numbers will be called the “section codes”; the measures of the primary mesh will be called the “sections”; and the table of FIG. 3 will be called the “section code table.” Incidentally, this section code table uses the same latitude×longitude coordinate system as that of the map database.

Incidentally, the section code basically covers the area of a square of 900″×900″ (i.e., a square of 810 thousand (seconds)²). In order to match the geography, however, the section code can be extended up to a square of 900 thousand (seconds)² at most, a latitudinally long region of 1,350″×600″, or a longitudinally long region of 450″×1,800″. In short, the section is composed of 1,000 blocks at most.

As to the measures of the secondary mesh, moreover, the hard disk of the controller 15 is so stored with the following table enumerated in a table of FIG. 4 that the code numbers “000” to “899” can designate the measures of the secondary mesh for each section while taking priority in the latitudinal direction from the lower left-hand side to the upper right-hand side in accordance with the positional relations in each section.

In detail, the measures of the section are coded one-to-one with the code numbers, as follows: the measure of the lower left-hand corner in the section is coded with the number “000”; the lowermost row is sequentially coded rightward with the numbers “001,” “002,” - - - , and “029”; and the row next to the bottom is sequentially coded leftward with the numbers “030,” “031, - - - , and “059.” From this point on, the measure of the upper right-hand corner is coded with the number “899.” In the following: these code numbers will be called the “block codes”; the individual measures of the secondary mesh will be called the “blocks”; and the table of FIG. 4 will be called the “block code table.”

The hard disk of the controller 15 is further stored, as to the measures of the ternary mesh, according to rules similar to those of the block codes, with the following table, as enumerated in a table of FIG. 5, so that the code numbers from “000” to “899” can designate the measures of the ternary mesh one-to-one for every blocks in accordance with the positional relations in each block. In the following these codes numbers will be called the “unit codes”; the individual measures of the ternary mesh will be called the “units”; and the table of FIG. 5 will be called the “unit code table.” Incidentally, the measures of this ternary mesh need not be equally sized.

The hard disk of the controller 15 is further stored with area codes in association with corresponding area information. The area codes indicate areas, each of which includes, as a basis, each of the measures of the ternary mesh. The corresponding area information includes a shape or a dimension. Instances of area codes composed of four characters are shown in a lower right-hand portion of FIG. 2. The first character of the area code indicates shape such as a square, circle, right triangle or the like. The characters (digits) from the second to the fourth indicate a dimension of the area.

For instance, “d” of the first character indicates that a corresponding area is shaped in a square and includes the corresponding ternary mesh in its lower left-hand corner. Here, the characters from the second to the fourth indicate a dimension (10″ in FIG. 2) of a side of the square. When the first is “r”, an area is shaped in a circle and includes the corresponding ternary mesh in its center of the circle. Here, the characters from the second to the fourth indicate a radius (10″ in FIG. 2) of the circle. Further, when the first is “p”, an area is shaped in a right triangle and includes the corresponding ternary mesh in its right-angled portion from which two sides of the right triangle extend to an upper and right-hand directions, respectively. Here, the characters from the second to the fourth includes “.” and digits prior to “.” indicates length (5″ in FIG. 2) of the side extending to the upper direction and digits posterior to “.” indicate length (10″ in FIG. 2) of the side extending to the right-hand direction. A unit of the dimension indicated by the digits from the second to the fourth can be not only “second (″),” but also “minute (′),” “km,” “m,” or the liked.

This area code is attached to the above section, block, and unit codes with “-” for forming one parameter code corresponding one-to-one to each unit. This code is called as an intrinsic code.

As explained above, once a certain intrinsic code is selected, longitude and latitude of a corresponding unit is designated with the section, block, and unit codes of the certain intrinsic code. By contrast, a shape and dimensions of a corresponding area including the above unit is designated with the area code. Here, a method of designating a point using the section, block, and unit codes is the same as that is disclosed in U.S. Pat. Nos. 6,006,160 or 6,122,594.

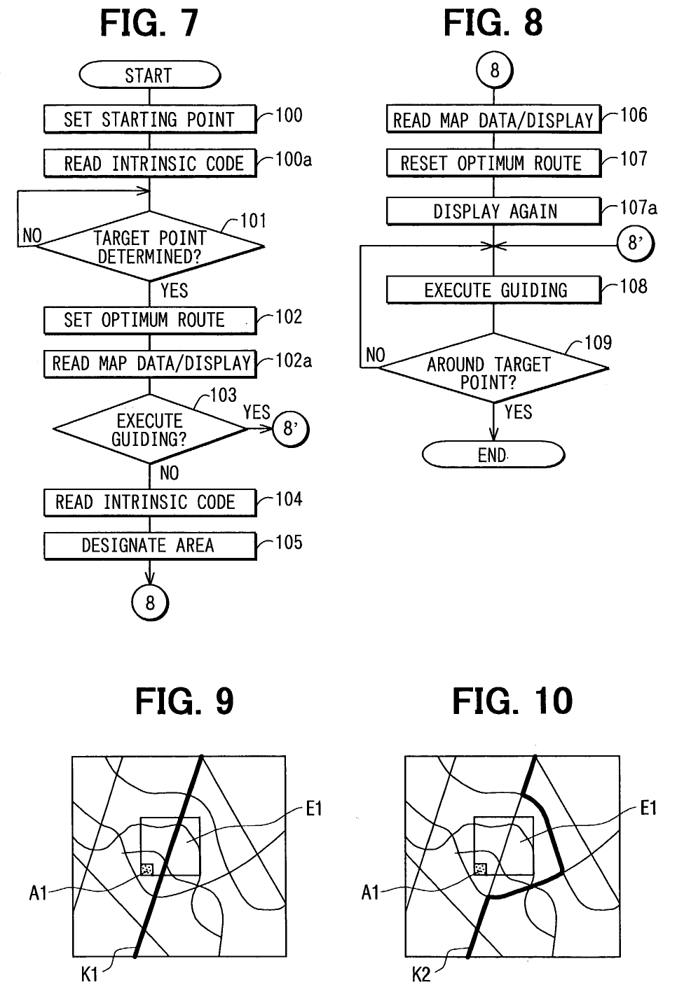

Procedure in the controller 15 for optimum route guiding using the above intrinsic code will be explained below. This procedure is started by designating an optimum route guiding mode from the control panel in the data set/display unit 16 and is executed by the routine, as shown in FIG. 7.

First of all, a current position of a vehicle is located on the basis of the received radio waves of the GPS receiver 11, and detection signals from the wheel speed sensor 12 and the azimuth sensor 13. The located position is set as a starting point (at Step 100). Next, an intrinsic code of a target point that is inputted through the control panel of the data set/display unit 16 by a user is read in (at Step 100a). Base on a section, block, and unit codes of the intrinsic code, longitude and latitude of the target point is designated with the tables in FIGS. 3,4,5, as disclosed in U.S. Pat. Nos. 6,006,160 or 6,122,594.

Next, through the control panel of the data set/display unit 16, the user determines that the designated target point displayed on the display screen properly indicates the target point, or moves a cursor on the display screen to determine the target point formally. In response to this determination of the target point by the user (yes at Step 101), the optimum route to the determined target point from the current point is calculated and set with the Dijkstra method (at Step 102). After this, a predetermined range of map data including the optimum route is read from the map database stored in the CD-ROM. The map is displayed on the display screen along with the optimum route based on the predetermined range of the map database (at Step 102a). Furthermore, whether the displayed optimum route is acceptable is inquired of the user through the display screen of the data set/display unit 16 (at Step 103).

For instance, there is a case where the above optimum route passes through temporarily restricted areas such as a festival site or a firework exhibition site. In this case, the user commands that the displayed optimum route is not acceptable (no at Step 103). Request of inputting, by the user, an intrinsic code of the restricted area that must be bypassed is thereby displayed on the display screen of the data set/display unit 16.

Next, the intrinsic code of the restricted area that is inputted by the user is read in (at Step 104). Base on a section, block, and unit codes of the intrinsic code, longitude and latitude of the restricted area is designated with the tables in FIGS. 3,4,5, similarly in designating the target point. Furthermore, based on the area code of the intrinsic code, the area including the restricted area as a basis is designated (at Step 105).

Next, a predetermined range of map data including the restricted area is read from the map database stored in the CD-ROM. As shown in FIG. 9, a map is displayed on the display screen along with designating the restricted area E1, based on the predetermined range of the map database (at Step 106). In this instance, area E1 including point A1 as a basis is shown in FIG. 9, and the optimum route K1 is still set to pass through area E1.

The optimum route is next reset with the Dijkstra method so that connection between links outside area E1 and links inside area E1 is broken up and the optimum route can thereby bypass area E1 (at Step 107). As shown in FIG. 10, the above optimum route K1 is replaced with newly set optimum route K2 (at Step 107a). The display image is thereafter returned to the starting point, and the route guiding is executed based on the optimum route K2 reset at Step 107 (at Step 108).

In the above embodiment, an intrinsic code includes a section, block, unit, and area codes, so that an area includes, as a basis, a point designated as the third mesh. However, an intrinsic code can include only a section, block, and area codes, so that an area includes, as a basis, a point designated as the second mesh.

In the above embodiment, an intrinsic code including an area code is used for setting a route that bypasses a restricted area. However, the intrinsic code including the area code can be also used for setting an area as a target, or setting facilities or sites near an area as a target. For instance, it can be used for setting an optimum route to a parking lot near a certain area such as a festival site, or a firework exhibition site. It can be furthermore used for searching facilities inside or near an area.

In the above embodiment, a method and system for designating an area, and a method and system for displaying a map are directed to a car navigation system. However, other than the car navigation system, they are directed to handheld devices such as a portable navigation system, a personal handy phone system (PHS), or a cell phone.

In the above embodiment, while a map is displayed, an intrinsic code corresponding to an area can be shown by designating the area in the map with a cursor.

In the above embodiment, after an optimum route is once set, the optimum route is reset for bypassing a restricted area by inputting an intrinsic code corresponding to the restricted area. However, the intrinsic code corresponding to the restricted area can be inputted at first, so that the optimum route can be set at once.

Though the intrinsic code of the present invention includes a section, block, unit, and area codes, it can also include a code indicating height of an object existing in a point designated by the section, block, and unit codes of the intrinsic code.

What is claimed is:

1. A method of designating, in a map, a point and an area that includes the point as a basis, the method comprising steps of:
assigning, to the point, a point-designating code that corresponds to one of regions into which the map divided according to a coordinate system;
assigning an area-designating code to the area;
defining an intrinsic code by combining the point-designating code with the area-designating code;
designating the point in the map by the point-designating code within the intrinsic code; and
designating the area in the map by the area-designating code within the intrinsic code.

2. A method of displaying, on a display, a map including an area that includes a point as a basis, the method comprising steps of:
assigning, to the point, a point-designating code that corresponds to one of regions into which the map divided according to a coordinate system;
assigning an area-designating code to the area;
defining an intrinsic code by combining the point-designating code with the area-designating code;
designating the point in the map by the point-designating code within the intrinsic code;
designating the area in the map by the area-designating code within the intrinsic code;
reading a certain map including the designated area from a map database; and
displaying the certain map on the display along with designating the designated area in the displayed map.

3. An area-designating system of designating, in a map, a point and an area that includes the point as a basis, the system comprising:
inputting means for inputting an intrinsic code that includes a point-designating code and an area-designating code, wherein the point-designating code that corresponds to one of regions into which the map divided according to a coordinate system is assigned to the point and the area-designating code is assigned to the area;
storing means for storing relation of one-to-one correspondence between the point-designating code and the point and relation of one-to-one correspondence between the area-designating code and the area; and
designating means for designating, referring to the stored relations of the one-to-one correspondence, the point in the map by the point-designating code within the intrinsic code and the area that includes the point as the basis in the map by the area-designating code within the intrinsic code when the intrinsic code is inputted through the inputting means.

4. A system of displaying, on a display, a map including an area that includes a point as a basis, the system comprising:
inputting means for inputting an intrinsic code that includes a point-designating code and an area-designating code, wherein the point-designating code that corresponds to one of regions into which the map divided according to a coordinate system is assigned to the point and the area-designating code is assigned to the area;
storing means for storing relation of one-to-one correspondence between the point-designating code and the point and relation of one-to-one correspondence between the area-designating code and the area;
designating means for designating, referring to the stored relations of the one-to-one correspondence, the point in the map by the point-designating code within the intrinsic code and the area that includes the point as the basis in the map by the area-designating code within the intrinsic code when the intrinsic code is inputted through the inputting means; and
displaying means for reading a certain map including the designated area from a map database to display the certain map on the display along with designating the designated area in the displayed map.

5. A system of guiding a route, comprising:
inputting means for inputting an intrinsic code that includes a point-designating code and an area-designating code, wherein the point-designating code that corresponds to one of regions into which a map divided according to a coordinate system is assigned to a point and the area-designating code is assigned to an area that includes the point as a basis;
storing means for storing relation of one-to-one correspondence between the point-designating code and the point and relation of one-to-one correspondence between the area-designating code and the area;
designating means for designating, referring to the stored relations of the one-to-one correspondence, the point in the map by the point-designating code within the intrinsic code and the area that includes the point as the basis in the map by the area-designating code within the intrinsic code when the intrinsic code is inputted through the inputting means; and
route guiding means for setting a route that reaches a target and bypasses the designated area, and executing route guiding according to the set route.
